(19) United States
(12) Patent Application Publication
(10) Pub. No.: US 2013/0017744 A1
(43) Pub. Date: Jan. 17, 2013

(54) GRAFT COPOLYMER AND REPELLENT COMPOSITION

(71) Applicants: Hisako Nakamura, Settsu-shi (JP); Takashi Enomoto, Settsu-shi (JP); Anthony A. Parker, Mantua, NJ (US); Joseph J. Marcinko, Mantua, NJ (US); Franklin A. Adamsky, Decatur, AL (US); Bradley H. Hartong, Decatur, AL (US)

(72) Inventors: Hisako Nakamura, Settsu-shi (JP); Takashi Enomoto, Settsu-shi (JP); Anthony A. Parker, Mantua, NJ (US); Joseph J. Marcinko, Mantua, NJ (US); Franklin A. Adamsky, Decatur, AL (US); Bradley H. Hartong, Decatur, AL (US)

(73) Assignee: DAIKIN INDUSTRIES, LTD., Osaka-shi, Osaka (JP)

(21) Appl. No.: 13/638,463

(22) PCT Filed: Mar. 29, 2011
(86) PCT No.: PCT/JP2011/058490

§ 371 Date: Sep. 28, 2012

Related U.S. Application Data
(60) Provisional application No. 61/319,196, filed on Mar. 30, 2010.

(51) Int. Cl. C08L 51/00; C08K 3/20; B05D 5/00; B32B 27/10; B32B 5/16; B32B 3/26; B32B 15/082; C08F 261/04; B32B 17/10

(52) U.S. Cl. 442/59; 524/543; 525/59; 427/385.5; 428/422; 428/319.3

(57) ABSTRACT

A repellent composition including an aqueous continuous phase and a graft copolymer dispersed in the aqueous continuous phase. The graft copolymer has a water soluble polymer trunk having hydroxyl groups and a branch having a C₆-perfluoroalkyl group bonded to the polymer trunk at a carbon atom substituted with the hydroxyl group. Also disclosed is a method of making the graft copolymer and a substrate treated with the repellent composition.

### CROSS-REFERENCE TO RELATED APPLICATIONS

This Application claims benefit under 35 U.S.C. §119(e) of U.S. Provisional Application No. 61/319,196 filed Mar. 30, 2010, incorporated herein by reference in its entirety.

### TECHINICAL FIELD

This invention relates to a graft copolymer, where opposing chemical properties, such as a hydrophilic portion and a hydrophobic portion, are combined into one molecule, and a repellent composition comprising the graft copolymer. The graft copolymer comprises both a trunk portion and extension portions (that is, grafts or branches) bonding to the trunk portion.

### BACKGROUND ART

Products containing perfluorocarbon groups have a long history of providing fluid repellency to a variety of substrates, including paper, textile, carpet, and nonwoven applications (e.g., “Technology of Fluoropolymers”, J. G. Drobny, CRC Press, 2001, Chapter 6). In particular, fluorochemical-containing treatments have been beneficially used for treating paper substrates for the express purpose of improving the paper's resistance to penetration by grease and oil. This oleophobicity is useful in a variety of paper applications for quick service restaurant food wrap and pet food bags, as well as carbonless fan-apart forms and other specialty applications (“The Sizing of Paper”, J. M. Gess & J. M. Rodriquez ed, TAPPI Press, 2005, Chapter 8)

Graft copolymers may comprise numerous types of structures. Typically, graft and block copolymers are both presented as having long sequences of 2 or more types of monomers. A general discussion of graft copolymers appears in the textbook “Principles of Polymerization”, G. G. Odian, Wiley Interscience, 1991, 3^{rd} edition, page 715-725. This discussion teaches, among several paths, that the ceric (IV) ion may be used to cause trunk polymers containing secondary alcohols, such as cellulose or polyvinyl alcohol, to undergo redox reactions with the ceric ion. The resulting polymer radicals are capable of initiating polymerization, thus creating homo or copolymer branches off of the main polymer chain. The resulting branched copolymer is one type of graft copolymer. Graft copolymers provide a vehicle for combining attributes of widely varying monomers into a structure where those attributes are retained.

Kang-gen Lee et.al. (U.S. Pat. No. 6,136,896) teach graft copolymers using diorganosiloxanes. These graft copolymers, however, are not built from a trunk, as the trunk is assembled during polymerization of various ‘macromonomers’ with other monomers to create the graft copolymer, and do not have application for oil and grease resistance. Matakawa (U.S. Pat. No. 6,503,313) teaches a graft copolymer incorporating fluorinated and siloxane groups. The resulting graft copolymer is similar in structure to that of Kang-gen Lee. The resulting composition finds primary end use in exterior building coatings, and the organic solvent utilized in the polymerization would not make it suitable for the present end uses. Hinterwaldner et.al. (U.S. Pat. No. 5,070,121) teaches a graft copolymer primarily for barrier protection and corrosion resistance. This graft polymer is a melt film that self-polymerizes during application and includes oligomeric material, which would not be suitable for food contact applications considered in the present invention.

Walker (U.S. Pat. No. 4,806,581) teaches a graft copolymer prepared through bulk polymerization. While this reference includes unspecified fluoroacrylates as one of the potential monomers, the bulk polymerization pathway is the primary teaching, which is not physically realistic for preparation of polymers of the present invention. Others teach about block copolymers of fluoroacrylates for treatment of textiles (U.S. Pat. Nos. 6,855,772, 6,617,267, 6,379,753), however, these graft copolymers, which may contain fluoroacrylates, are prepared based on monomeric or polymeric maleic anhydride. The maleic anhydride creates the reactive bonding site to textile fibers. These reactive groups present an inherent instability in treatment solutions, and are hence at a disadvantage from the present invention.

Relative to the present invention, Miller et.al. (U.S. Pat. No. 5,362,847) teaches a graft copolymerization utilizing an ethylene oxide and/or propylene oxide trunk onto which is grafted a fluoroacrylate monomer. The resulting graft copolymer is then combined with a cross-linking agent to create a durable coating. Unlike the present invention, this reference conducts the graft polymerization in a toxic organic solvent, such as xylene. Removal of organic solvents from the resulting polymers is problematic, with residual solvent being a regulatory concern.

U.S. Patent Application Publication U.S. 2005/0096444 A1 to Lee et al. discloses a graft copolymer created from an assembly of vinyl containing monomers and macromonomers. This is similar in character to Kang-gen Lee's work referenced earlier. These macromonomer polymers are polymerized in a toxic organic solvent after functionalization of the macromonomer with acid chloride. The hydrocarbon trunk chain assembled as a result of the organic solvent polymerization does not contain hydroxyl groups nor is it capable of acting as a self-emulsifying agent as described in the present invention.

The use of cerium as an initiator for use in creating graft copolymers is disclosed in U.S. Pat. No. 2,922,768. Cerium initiation has been broadly used for the grafting of natural polymers, such as starch and cellulose (U.S. Pat. Nos. 4,375,535, 4,376,852, 5,130,394, and 5,667,885), however, the incorporation of fluorinated functionality has not been disclosed.

WO2007/018276 discloses a graft copolymer having a fluorine-containing group. However, the use of a C₆-perfluoroalkyl group is not described concretely.

### DISCLOSURE OF THE INVENTION

### Problems to be Solved by the Invention

The benefits of substrate treatment by fluorochemicals are widely appreciated. A difficulty often arises in the treatment of the substrate to produce those benefits. The present invention solves the problem of the use of emulsifiers to effect the emulsion polymerization of many commercial fluorinated copolymers. These emulsifiers can interfere in numerous ways to reduce the performance of the fluorinated copolymer on a substrate. The present graft copolymer also solves the problem of having good bonding to substrates, through the trunk polymer's hydrogen bonding capacity. The need for good hydrogen bonding co-monomers, such as acrylamide, which has regulatory concerns, is reduced or eliminated. In addition, decreasing the degree of hydrolysis of the trunk polymer can be used to improve adhesion to hydrophobic surfaces. The present invention is also capable of delivering advantageous performance from fluorinated vinyl monomers of a wide variety of perfluorinated chain lengths, due to the structure of the grafts. Fluorinated copolymer performance can suffer when the fluoroalkyl chain length is shortened in conventional polymers. The present invention reduces or eliminates the need for co-solvents that increase the hazardous volatile organic compound content of other fluorinated copolymers.

The fluorine-processed carpet has the problem that performance (water- and oil-repellency, and soil resistance ability) deteriorates because of falling off of the repellent agent with a detergent or a friction at the time of the cleaning.

The carpet before the use is subjected to the heat-treatment after the carpet is treated with the repellent agent, but it is difficult that heat is applied to the carpet spread indoors.

A repellent agent, which can give performances at normal temperature (20° C.) without heating, is required.

The fluorinated graft copolymer of the present invention solves the problem of incorporating co-monomers of widely divergent reactivity ratios to vinyl perfluoroacrylates, in that the graft polymerization technique can be applied to the present invention multiple times. This allows for incorporating a wide variety of copolymers along one trunk polymer without the difficulties normally experienced during a conventional polymerization. The present invention also solves the difficult problem of how to incorporate grafts along an existing trunk chain. There is no need to use dangerous, highly reactive intermediates such as acid chlorides to create these grafted chains.

The fluorinated graft copolymer of the present invention may reduce the need to use toxic and/or volatile organic compound (V.O.C.) contributing organic solvents to affect the polymerization of the fluorinated copolymer, because the continuous phase is water. Hence these graft copolymers are inherently miscible in nearly all treatment systems, as these are primarily aqueous-based. The fluorinated graft copolymer of the present invention may extend the range of application of repellent treatment by eliminating the need to heat cure the treated substrate after treatment in order to develop the desired repellency properties.

### Means for Solving the Problems

Therefore, the present invention provides a graft copolymer and a repellent composition containing the same, which provides the above described benefits in terms of both safety and performance, and to a method of making the graft copolymer.

The present invention provides a graft copolymer comprising:
a water-soluble polymer trunk having a hydroxyl group; and
a branch having C₆-perfluoroalkyl group bonded, at a carbon atom substituted with the hydroxyl group, to the polymer trunk.

The branch bonds to the carbon atom substituted with the hydroxyl group of the water-soluble polymer trunk.

Further, the present invention provides a repellent composition comprising:
an aqueous continuous phase; and
a graft copolymer, dispersed in the aqueous continuous phase, comprising
a water-soluble polymer trunk having a hydroxyl group; and
a branch having a C₆-perfluoroalkyl group bonded to the polymer trunk at a carbon atom substituted with the hydroxyl group.

Additionally, the present invention provides a method of treating a substrate with the repellent composition.

### Effect of the Invention

The repellent composition can impart, to the substrate, excellent water- and oil-repellency and soil resistance, and excellent durability of water- and oil-repellency and soil resistance.

Since the repellent composition of the present invention can provide the performances by drying at a room temperature (20° C.), the repellent composition can be used as a post-processing agent. Excellent water- and oil-repellency and soil resistance can be obtained by treating the carpet with the repellent composition of the present invention, after the carpet has been used.

According to the present invention, the polymerization is conducted by radical or ionic initiation in a continuous phase so that the polymerization of extension portion from the trunk portion, the compositions of the trunk and graft and the number and length of the graft are fully controlled in order to give desirable specified structure for final use performances of the graft copolymer.

According to the present invention, the final use properties such as oil repellency, grease repellency and/or water repellency in some preferred embodiments can be improved by the application of the repellent composition. Thus treated substrate can maintain preferable properties of the untreated substrate such as porosity and surface feeling.

In a preferred embodiment, the repellent composition contains an emulsifier (or a surfactant) in an amount of at most 10% by weight, based on the repellent composition. In another preferred embodiment, the repellent composition contains a solvent in an amount of at most 50% by weight, based on the repellent composition.

The present invention provides a method of preparing a graft copolymer, which comprises: chain polymerizing a monomer capable of chain polymerizing with said trunk polymer to form a graft copolymer constituting branch(es) from the trunk polymer derived from said monomers,
wherein said chain polymerization is conducted in continuous phase, in the presence of a polymerization initiator under neutral to acidic pH conditions, and substantially in the absence of an emulsifying agent or in the presence of an emulsifying agent.

In a preferred embodiment, the polymerization initiator comprises a redox system including an oxidizing agent and a reducing agent where the trunk polymer is the reducing agent and the oxidizing agent comprises a multivalent metal ion.

In yet another preferred embodiment, the multivalent metal ion serving as an oxidizing agent comprises Ce⁴⁺.

In still yet another preferred embodiment, the trunk polymer is water soluble or water dispersible.

In still yet another preferred embodiment, the continuous phase is an aqueous continuous phase.

In still yet another preferred embodiment, the monomers comprise fluorine-containing monomers.

In still yet another preferred embodiment, the continuous phase is an aqueous continuous phase and the fluorine-containing monomers are soluble or dispersible in the continuous phase in the presence of the trunk polymer.

In still yet another preferred embodiment, the fluorine-containing monomers are not soluble or dispersible in the continuous phase in the absence of the trunk polymer.

The present invention provides a substrate treated with the repellent composition.

In a preferred embodiment, the substrate is a fibrous substrate selected from the group consisting of paper, textiles, carpet and nonwoven materials.

In yet another preferred embodiment, the substrate is nonfibrous selected from the group consisting of metals, plastics, leathers, composites, and glasses, both treated and untreated, porous and non porous.

In yet another preferred embodiment, the treated substrate is prepared by applying the repellent composition, optionally in combination with other compounds, via any of spraying, dipping and padding.

In still yet another preferred embodiment, the treated substrate is prepared by incorporating the repellent composition while forming said substrate or by incorporating the repellent composition into components constituting said substrate.

In still yet another preferred embodiment, the repellent composition further comprises a salt of a type and in an amount sufficient to enhance exhaustion of the graft copolymer onto a treated fibrous substrate prepared by immersing the substrate in the repellent composition, wherein the substrate is heated either before or after or both before and after immersing in the repellent composition to remove excess water.

In still yet another preferred embodiment, the invention provides a treated fibrous substrate prepared by immersing a fibrous substrate in the repellent composition, said composition being delivered at a pH below 3.5 to enhance exhaustion of graft copolymer onto the substrate, and heating the substrate to remove excess water.

In still yet another preferred embodiment, the invention provides a substrate treated with the repellent composition.

In still yet another preferred embodiment, the treated substrate is further subjected to one or both of washing and drying after treatment with the graft copolymer.

### MODES OF CARRYING OUT THE INVENTION

The graft copolymer of the invention may contain both hydrophilic and hydrophobic and/or lipophobic portions. The graft copolymers of the present invention contain a trunk polymer. An embodiment of this trunk polymer is hydrophilic and water soluble or dispersible in its unmodified state. A preferred embodiment of the trunk polymer contains hydroxyl groups. In a further preferred embodiment, the trunk polymer contains secondary hydroxyl groups substituted on the carbons of the primary hydrocarbon trunk polymer chain. Examples of these types of trunk polymers may be natural and modified starches, celluloses, hemi-celluloses, synthetic polyvinyl alcohols, and polyvinyl alcohols/co vinyl acetates (that is, a homopolymer of vinyl alcohol or a copolymer of vinyl alcohol and vinyl acetate). The trunk polymer may also be protein-based.

Preferably, the trunk polymer comprises polyvinyl alcohol/co-vinyl acetate and more preferably contains a predominant fraction of units derived from polyvinyl alcohol. Vinyl alcohol monomer is not commercially available, so in one possible industrial route, vinyl acetate is polymerized via chain polymerization to a desired molecular weight. The resulting polyvinyl acetate (PVAc) can then be subjected to alcoholysis with methanol via a base-catalyzed reaction. The degree of alcoholysis is controlled to give a desired polyvinyl alcohol concentration. Polyvinyl alcohol/co-vinyl acetates are commercially available in a wide variety of degrees of alcoholysis and molecular weight, under such trade names as CELVOL.

The hydroxyl group content of the polymer trunk is such that the trunk polymer is water soluble or dispersible in its unmodified state. Generally, the polymer trunk may have 1 to 100 percent hydroxyl substitution, particularly, 50 to 100 percent hydroxyl group substitution of a polyvinyl acetate trunk polymer prepared from 100% polyvinyl acetate. Particularly preferable trunk polymer is polyvinyl alcohol and polyvinyl alcohol/co-vinyl acetate.

In other variations on the trunk polymer chain, the hydroxyl concentration may vary from its natural state up to 100%, for example from 20% to 80% of the potential hydroxyl sites for that particular trunk polymer chain.

The hydroxyl groups substituted on the carbons of the primary hydrocarbon trunk polymer chain are preferably secondary hydroxyl groups. This composition may be obtained via the manufacturing process described above.

A description of the branches having fluorinated groups bonded to the polymer trunk at a carbon atom substituted with a hydroxyl group is included below with reference to fluorinated (and fluorine-free) monomers for use in synthesizing the graft copolymer. The number of branches having fluorinated groups per molecule of the graft copolymer depends on its intended use and application. Generally, the weight ratio of the polymer trunk to branches having fluorinated groups (derived, e.g., from vinyl monomers having a polyfluorinated group) may be from 1:99 to 99:1, preferably from 10:90 to 90:10, particularly 25:75 to 75:25. Other branches not containing fluorine (derived, e.g., from fluorine-free vinyl monomers) may also be present in an amount so as to still achieve the objects of the invention, generally in a weight ratio of up to 90% by weight, for example 10% to 60% of the graft copolymer. The fluorine-free monomers may also be copolymerized with the fluorinated monomers to create a copolymer graft chain. This graft chain may be random or block, linear or branched in character. The graft chain may consist of the fluorinated monomer or may consist of the fluorinated monomer and the fluorine-free monomer.

The amount of the graft copolymer in the repellent composition is generally from about 5 wt % to about 50 wt %, based on the repellent composition. When present as a dispersion in the aqueous continuous phase, the graft copolymer particles have an average particle size (equivalent diameter) of from 0.05 μm to 2.0 μm. The graft copolymer preferably has a number average molecular weight of from about 1,000 to about 1,000,000, more preferably from about 20,000 to about 200,000.

In addition to the graft copolymer, the repellent composition may further contain additives intended to improve the stability and/or performance of the graft copolymer, without particular limitation so long as the objects of the invention are attained.

The continuous phase (which is generally 50% to 95% by weight, based on the repellent composition) is generally water, but may further include additional co-solvents in an amount of up to 50% by weight, preferably up to 30% by weight, and most preferably up to 10% by weight, based on total product (i.e., the repellent composition). In another preferred embodiment, the repellent composition contains substantially no co-solvent (for example, the continuous phase consists of water).

As used herein, the language “substantially contains no co-solvent” means that the repellent composition contains a solvent other than water in an amount up to 8% by weight, preferably up to 2% by weight, and most preferably contains no solvent other than water.

As used herein, the terms “water soluble” and “water dispersible” relative to the graft copolymer mean that the composition may either fully dissolve in water or form a stable colloidal dispersion.

The repellent composition may contain or may not contain. emulsifying agents (or surfactants) such as fatty alcohol ethoxylates and other emulsifying agents known in this field of art. The emulsifying agent may be various emulsifying agents such as cationic, anionic and nonionic emulsifying agents. The amount of the emulsifying agent may be 0 to 30 parts by weight, 1 to 20 parts by weight, based on 100 parts by weight of monomers.

In accordance with the method of preparing the graft copolymer of the invention, monomers capable of chain polymerization are utilized to create extensions (grafts) off of the trunk polymer chain. These monomers in general may have significantly different character and/or performance attributes than the trunk polymer of the graft. A preferred embodiment is fluoroalkyl and non-fluoroalkyl groups with radically polymerizable terminal groups. The graft copolymer of the present invention incorporates one or more of these monomers to create the graft copolymer. A further preferred embodiment is the group of monomers of fluoroacrylates, silicoacrylates, aliphatic acrylates, and other functional acrylates, such as those containing amines, amides, and halides useful for end use performance.

The perfluoroalkyl group-containing (meth)acrylate, R_{f}M, may be represented by the following general formula:

Rf—A²—OCOCCR¹⁸═CH₂ (R_{f}M)

wherein Rf is a perfluoroalkyl group having 6 carbon atoms, R¹⁸ is hydrogen, halogen (for example, fluorine, chlorine, bromine and iodine), or a methyl group, and A² is a divalent organic group.

Preferably, A² is a direct bond, an aliphatic group having 1 to 10 carbon atoms, an aromatic or cycloaliphatic group having 6 to 18 carbon atoms, a —CH₂CH₂N(R¹)SO₂— group (wherein R¹ is an alkyl group having 1 to 4 carbon atoms), a —CH₂CH(OZ¹)CH₂— group (wherein Z¹ is a hydrogen atom or an acetyl group.), a —(CH₂)ₘ—SO₂—(CH₂)ₙ— group, or a —(CH₂)ₘ—S—(CH₂)ₙ— group (wherein m is from 1 to 10 and n is from 0 to 10.).

Examples of the perfluoroalkyl group-containing (meth)acrylate include:

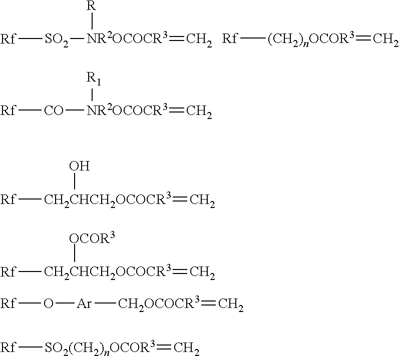

wherein Rf is a perfluoroalkyl group having 6 carbon atoms,
R¹ is hydrogen or an alkyl group having 1 to 10 carbon atoms,
R² is an alkylene group having 1 to 10 carbon atoms,
R³ is hydrogen, halogen (for example, chlorine, fluorine and bromine), or a methyl group,
Ar is arylene group which optionally has a substituent group, and
n is an integer of 1 to 10.

Specific examples of the perfluoroalkyl group-containing (meth)acrylate include the following.
CF₃ (CF₂) ₅ (CH₂) ₂ OCOCH═CH₂
CF₃ (CF₂) ₅ (CH₂) ₂ OCOCCl═CH₂
CF₃ (CF₂) ₅ (CH₂) ₂ OCOC (CH₃)═CH₂
CF₃ (CF₂) ₅ (CH₂) ₂ OCOCF═CH₂
CF₃ (CF₂) ₅ (CH₂) ₂ OCOCH═CH₂
CF₃ (CF₂) ₅ (CH₂) ₂ OCOC (CH₃)═CH₂
CF₃ (CF₂) ₅ (CH₂) ₂ OCOCCl═CH₂
CF₃ (CF₂) ₅ (CH₂) ₄ OCOCH═CH₂
CF₃ (CF₂) ₅ SO₂N (CH₃) (CH₂) ₂ OCOCH═CH₂
CF₃ (CF₂) ₅ SO₂N (C_{2 H}₅) (CH₂) ₂ OCOC (CH₃)═CH₂
CF₃ (CF₂) ₅ CH₂ CH (OCOCH₃) CH₂ OCOC (CH₃)═CH₂
CF₃ (CF₂) ₅ CH₂CH(OH)CH₂OCOCH═CH₂
CF₃ (CF₂) ₅ SO₂N(CH₃) (CH₂)₂ OCOCH═CH₂
CF₃ (CF₂) ₅ SO₂ (CH₂) ₃ OCOCH═CH₂

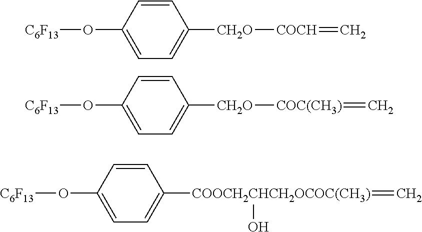

As a matter of course, at least two types of the fluoroalkyl group-containing (meth)acrylates can be used in combination.

The vinyl monomer having the perfluoroalkyl group may be another fluorine-containing monomer. Examples of the another fluorine-containing monomer include a fluorinated olefin (having, for example, 2 to 21 carbon atoms) such as CF₃ (CF₂) ₅CH═CH₂.

Examples of the fluorine-free vinyl monomer, VM, include a (meth)acrylate ester. The (meth)acrylate ester may be an ester between (meth)acrylic acid and an aliphatic alcohol such as a monohydric alcohol and a polyhydric alcohol (such as divalent alcohol).

Examples of the fluorine-free vinyl monomer include: (meth)acrylates such as methyl methacrylate, 2-ethylhexyl (meth)acrylate, cyclohexyl (meth)acrylate, lauryl (meth) acrylate, stearyl (meth) acrylate, hydroxyalkyl (meth) acrylate, tetrahydrofurfuryl (meth) acrylate, polyoxyalkylene (meth) acrylate, 3-chloro-2-hydroxypropyl (meth)acrylate, glycidyl (meth)acrylate, N,N-dimethylaminoethyl (meth) acrylate, N,N-diethylaminoethyl (meth) acrylate, benzyl (meth) acrylate, hydroxypropyl mono(meth)acrylate, 2-hydroxy-3-phenoxypropyl(meth)acrylate, 2-hydroxyethyl(meth)acrylate, glycerol mono(meth)acrylate, β-acryloyloxyethyl hydrogen succinate, methacryloyloxyethyl- hydrogen phthalate, acryloyloxyethylhexahydrophthalic acid, 2-acryloyloxyethylphthalic acid, 2-acryloyloxyethyl-2-hydroxyethylphthalic acid, (meth)acrylic acid hydroxypropyltrimethylammonium chloride, dimethylaminoethyl (meth) acrylate, diethylaminoethyl (meth) acrylate, 2-acryloyloxyethyl dihydrogen phosphate, glycosyl ethyl (meth) acrylate, (meth) acrylamide, 2-hydroxy-3-acryloyloxypropyl (meth) acrylate, 2-methacryloyloxyethyl acid phosphate, and hydroxypivalic acid neopentyl glycol diacrylate; styrenes such as styrene and p-isopropylstyrene; (meth)acrylamides such as (meth)acrylamide, diacetone(meth)acrylamide, N-methylol(meth)acrylamide, N-butoxymethylacrylamide, and 2-acrylamide-2-methylpropanesulfonic acid; and vinyl ethers such as vinyl alkyl ether.

Examples thereof further include ethylene, butadiene, vinyl acetate, chloroprene, vinyl halide such as vinyl chloride, vinylidene halide, acrylonitrile, vinyl alkyl ketone, N-vinylcarbazole, vinyl pyrrolidone, 4-vinylpyridine, and (meth)acrylic acid.

The fluorine-free vinyl monomer may be a silicon-containing monomer (for example, (meth)acryloyl group-containing alkylsilane, (meth)acryloyl group-containing alkoxysilane, and (meth)acryloyl group-containing polysiloxane).

Examples of the silicon-containing monomer include: (meth) acryloxytrialkylsilane, (meth)acryloxy-trialkoxysilane, (meth) acryloxypolysiloxane, (meth) acryloxypropyltrialkylsilane, (meth)acryloxypropyl-trialkoxysilane, (meth) acryloxypropylpolysiloxane, allyltrialkylsilane, allyltrialkoxysilane, allylpoly-siloxane, vinyltrialkylsilane, vinyltrialkoxysilane, and vinylpolysiloxane.

The (meth)acryloxypropylpolysiloxane may be:

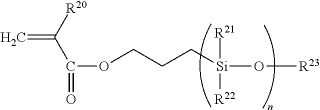

wherein R²⁰ is H or CH₃, R²¹ is H or CH₃, R²² is H or CH₃, R²³ is H or CH₃, and n is from 1 to 100 (for example, (meth)acryloxypropylpolydimethylsiloxane).

At least two types of the fluorine-free vinyl monomers can be also used in combination.

An alkyl (meth)acrylate is preferable as the fluorine-free vinyl monomer. In the alkyl (meth)acrylate, the carbon atom number of the alkyl group is preferably 1 to 30, for example, 1 to 20. The alkyl group is linear, branched or cyclic (for example, 4-30 carbon atoms). Examples of the alkyl group include a methyl group, an ethyl group, a n-propyl group, an isopropyl group, a n-butyl, an isobutyl, a t-butyl, a n-pentyl group, a cyclopentyl group, n-hexyl group, a cyclohexyl group, a lauryl group, a stearyl group, a behenyl group, and an isobornyl group.

A weight ratio of the fluorine-containing monomer to the fluorine-free vinyl monomer may be 100-5/0-95, usually 95-5/5-95, preferably 80-10/20-90, more preferably 70-15/30-85, for example, 70-40/30-60. In this range, the water-repellency, the oil repellency and the soil resistance are high.

Creation of the polymeric grafts from the trunk is performed via initiation of a chain polymerization of the monomer via standard methods (radical or ionic) well known to those skilled in the art. In a preferred embodiment, an initiator that is soluble in the continuous phase is used to initiate chain polymerization starting at the trunk polymer and allowing for the polymerization reaction to proceed. A further preferred embodiment utilizes redox initiators for this purpose. An example is the use of ceric ion or other oxidizing agent, such as a multivalent ion selected from V⁵⁺, Cr⁶⁺ and Mn³⁺ to form a free radical along the trunk chain of a polyvinyl alcohol, and the subsequent polymerization proceeding from that free radical.

Further examples of the polymerization initiator include a combination of a peroxide and a reducing agent, a combination of an inorganic reductant and an oxidant or an inorganic-organic redox pair, especially where the trunk polymer or fluorine-containing monomer may act as one component of the redox pair. Other examples are described by Odian, previously referenced. The content of the polymerization initiator depends on the trunk polymer and monomer selection, but is generally from 0.01% to 2.0% by weight of the composition.

A novel and unexpected aspect of the present invention is the unique ability of the trunk polymer, by the choice of its structure, to act as an emulsifying agent for the monomer(s) of this polymerization, which are potentially not soluble in the continuous phase. Not being bound to theory, it appears that the trunk polymer takes the place of surface active agents that would typically be required to stabilize monomer in the continuous phase to allow for polymerization. In conventional emulsion and microemulsion polymerizations, these surface active agents are difficult to remove after polymerization is completed, and can act to the detriment of the final polymer's performance and regulatory capacity. Due to the diverse nature of the monomers employed, it may still be necessary to add some emulsifiers and/or co-solvents which enhance the stability of either the polymerization or the resulting graft copolymer, but the amounts and types of these are significantly reduced.

The present invention is characterized in that the mild conditions are required to bring about the polymerization. A preferred embodiment of the present invention utilizes an aqueous continuous phase for the conduction of the graft polymerization. Depending on the selection of initiators and other components, the graft polymerizations of the present invention can take place at room temperature and atmospheric pressure conditions, or at elevated conditions. These polymerizations take place under mild agitation and proceed to a high degree of conversion without excessive effort in a reasonable amount of time. The resulting graft copolymer products are stable dispersions in the continuous phase.

Generally, the reaction conditions suitable for practice of the invention are a temperature of from 15° C. to 80° C. at a pressure of 0 psig to 100 psig and a polymerization time of from 5 seconds to 72 hours. It is also preferred that the reaction take place under neutral to acidic pH conditions (for example, pH of 7 to 1).

Of particular interest in these reactions are the ratios (molar ratio) of initiator to monomer, initiator to reactive site on trunk polymer, and monomer to reactive site on trunk polymer.

### Preparation of Repellent Composition:

The graft copolymer, prepared as described above, is dispersed in water or an aqueous phase containing mainly water, in an amount of from 1% to 50% by weight of total using low-shear mechanical mixing. Other agents, such as but not limited to buffers, film forming agents, foaming agents, blocking agents, cross linkers, salts, biological control agents, retaining agents, blooming agents, stabilizers, water soluble polymers and/or binders may be further added to the repellent composition. The repellent composition thus prepared is stable and may be stored for use as described in further detail below.

The repellent composition may further contain a solvent or organic solvent or water soluble organic solvent at up to 50 parts of the total repellent composition. Specific examples of the water soluble organic solvent used for this purpose are acetone, ethylene glycol monoethyl ether acetate, ethylene glycol monoethyl ether, ethylene glycol monomethyl ether, ethylene glycol monobutyl ether, propylene glycol monomethyl ether, propylene glycol monomethyl ether acetate, dipropylene glycol monomethyl ether, tripropylene glycol monomethyl ether, propylene glycol butyl ether, propylene glycol dibutyl ether, ethyl-3-ethoxy propionate, 3-methoxy-3-methyl-1-butanol, 2-tert-butoxy ethanol, isopropyl alcohol, n-butyl alcohol, isobutyl alcohol, ethyl alcohol, ethylene glycol, propylene glycol, dipropylene glycol or triproylene glycol. At least two types of the water soluble organic solvent can be also used in combination.

The repellent composition may further contain a surfactant having nonionic, anionic, cationic, and/or amphoteric character in an amount of from 0.1 to 10 wt % of the total composition. The surfactant used for dispersing the polymer may be a cationic emulsifier, an anionic emulsifier, an amphoteric emulsifier or a nonionic emulsifier. General chemical categories of the surfactant used for this purpose include, but are not limited to ethoxylated alcohols, alkyl phenols, ethoxylated fatty acids, ethoxylated fatty alcohols, ethoxylated fatty amines, ethoxylated glycerides, sorbitan esters, ethoxylated sorbitan esters, esters, phosphate esters, glycerin esters, block polymers, propoxylates, alkanol amides, amine oxides, alkyl amine oxides, lanolin derivatives, hydroxysulfobetaines, amine amides, and ethoxylated propoxylated ethers for nonionics, fatty acid salts, sulfates, sulfonates, phosphates, ether carboxylates, naphthalene sulfonates, formaldehyde condensates, and carboxylates for anionics, and alkyl amine salts and quaternary ammonium salts for cationics, and alkyl betaines, alanines, imidazolinium betaines, amide betaines, acetic acid betaines, and amine oxides for amphoterics.

Specific examples of the nonionic emulsifier include a condensation product of ethylene oxide with hexadecanol, n-alkanol, sec-alkanol, t-alkanol, oleic acid, alkane(C₁₂-C₁₆)thiol, sorbitan monofatty acid (C₇-C₁₉) or alkyl(C₁₂-C₁₈)amine and the like, and glycol, alkyl glycol ether, diglycol alkyl ether, ketones and esters.

Specific examples of the anionic emulsifier include sodium alkyl (C₁₂-C₁₈) sulfate, alkane (C₁₂-C₁₈) hydroxysulfonic acids and alkene derivative sodium salts, poly(oxy-1,2-ethanediyl), alpha-sulfo-omega-(9-octadecenyloxy)-ammonium salt and the like.

Specific examples of the cationic emulsifier include dodecyl trimethyl ammonium acetate, trimethyl tetradecyl ammonium chloride, hexadecyl trimethyl ammonium bromide, trimethyl octadecyl ammonium chloride, (dodecylmethyl-benzyl) trimethyl ammonium chloride, benzyl dedecyl dimethyl ammonium chloride, dialkyl dimethyl ammonium chloride, methyl dodecyl di(hydropolyoxyethylene) ammonium chloride, benzyl dodecyl di(hydropolyoxyethylene) ammonium chloride, benzyl dodecyl di(hydropolyoxyethylene) ammonium chloride and N-[2-(diethyl-amino)ethyl]oleamide hydrochloride.

Specific examples of the amphoteric emulsifier include lauryl betaine, lauryl dimethylaminoacetic acid betaine, stearyl betaine, and laurylcarboxymethylhydroxy-ethylimidazolinium betaine.

One type of the emulsifiers may be used or at least two types of the emulsifier may be also used in combination.

The repellent composition of the present invention may also contain stabilizers to maintain the uniformity of the dispersion. These stabilizers may be polymeric, with specific examples including hydroxypropylcellulose, poly(ethylene oxide), sodium styrene sulfonate, or poly (acrylic acid) sodium salt.

The dispersion according to the present invention can be applied to the substrate preferably by coating, dipping, spraying, padding, roll coating, or combination of these procedures. For example, a solution having a solids content of 0.1 to 10% by weight of the present invention can be used. An example prepared for the treatment of a cellulose (paper) substrate may consist of an aqueous mixture of cooked ethylated corn starch (2% to 20% by weight of solution) combined with the fluorochemical (0.1 to 10% by weight of total solution) of the present invention. An example prepared for the treatment of nylon carpet substrate may contain an aqueous mixture of a stain blocking agent (0.1% to 10% by weight of substrate) and/or a foaming agent (0.1% to 10% by weight of total solution) combined with the fluorochemical (0.1% to 10% by weight of total solution) of the present invention.

### Preparation of Treated Substrates:

The application of these graft copolymers to substrates may proceed along all means familiar to those skilled in the art without particular limitation. The graft copolymers of the present invention may be applied to substrates for the purpose of enhancing certain performance characteristics while at the same time not altering other essential characteristics of that substrate via spraying, dipping, padding, or otherwise treating these substrates. After this treatment, these substrates may be further processed via washing, drying and/or subjected to additional finishing treatments. Another novel and unexpected aspect of the present invention is the stability of the graft copolymers during these treatment applications. An example is the treatment of paper or textiles, where the graft copolymer of the present invention is added to a solution containing multiple other treatments and/or compounds to form a repellent composition which is then applied to a paper or textile substrate. The high level of emulsifiers present in existing repellency treatment materials is often detrimental to the chemical and physical stability of this solution. Also, the uniformity of the substrate treatment may be negatively impacted by this solution instability.

Herein, the wordings “treatment of the substrates with the composition” means that the composition is applied to the substrates, and the wordings “treatment of the substrates with the composition” gives the result that the graft copolymer contained in the composition is adhered to the substrates.

The amount of graft copolymer incorporated into the treated substrate depends on the nature of the substrate, the composition of the graft copolymer and intended application. A treatment solution is prepared as previously discussed. This solution can be applied to the substrate preferably by coating, dipping, spraying, padding, roll coating, or a combination of these procedures. As an example of the padding application method, the substrate is padded (dipped) in a bath of the substrate solution, and then excess liquid is usually removed by a squeezing roll to give a dry pickup amount (the weight of dry polymer on the substrate) of from 0.01 to 10% by weight based on the weight of the substrate. Then, the treated substrate is preferably heated at 100-200° C.

U.S. Patent Application Publication No. 2003/0217824 to Bottorff describes various treatment methods and performance evaluation tests for paper as a substrate, and is incorporated herein by reference. U.S. Pat. No. 6,794,010 to Yamaguchi describes various treatment methods and performance evaluation tests for carpet as a substrate, and is incorporated herein by reference. U.S. Pat. No. 5,614,123 to Kubo describes various treatment methods and performance evaluation tests for textile as a substrate, and is incorporated herein by reference. U.S. Pat. No. 5,688,157 to Bradley describes various performance evaluation tests for nonwoven fabrics as a substrate, and is incorporated herein by reference. U.S. Pat. No. 5,688,157 to Bradley discusses internal treatment of nonwoven fabrics with fluorochemicals, while the present invention may also be applied topically, as discussed in U.S. Pat. No. 5,834,384 to Cohen, which is incorporated herein by reference. Another novel and unexpected aspect of the present invention is that drying of any of the treated substrates may occur at room temperature, with the desired repellency properties being imparted to the substrate.

In another preferred embodiment, the treated substrate is prepared by incorporating the repellent composition while forming the substrate or by incorporating the repellent composition into components constituting the substrate. For example, during the formation process of paper, the fluorochemical of the present invention may be added to an aqueous dilute cellulose fiber solution, along with a polymeric retaining agent, immediately before the formation of the paper. This paper is then further pressed, surface treated or coated, and dried. The drying may occur under either elevated or room temperatures.

The paper thus treated with the fluorochemical composition of the present invention will show increased resistance to oil, grease, and/or water penetration even when the paper is folded or creased, exposing the cellulose fibers. Another example of a non-surface treatment may be in the formation of nonwoven materials (See U.S. Pat. No. 5,688,157, discussed above), where the fluorochemical of the present invention is combined with the materials being compounded and a blooming agent prior to extrusion/spinning.

In another preferred embodiment, the treated substrate is prepared by exhausting the graft copolymer onto the substrate. U.S. Pat. No. 6,197,378 to Clark describes various treatment methods, formulations, and tests for the exhaust application, and is incorporated herein by reference. The bath prepared for exhaust application typically requires the addition of a metal salt such as but not limited to magnesium sulfate, sodium chloride, potassium chloride, sodium sulfate, calcium chloride barium chloride, zinc sulfate, copper sulfate, aluminum sulfate, and chromium sulfate.

The bath composition pH value can be 0.5 or higher, and the substrate is exposed to steam either before or after or both before and after treatment in the bath. Other components can also be included in the bath, such as stain blockers and acids required to adjust pH of the bath. In another preferred embodiment, the treated substrate is prepared by exhausting the graft copolymer onto the substrate. U.S. Pat. Nos. 5,851,595 and 5,520,962 to Jones describe various treatment methods, formulations, and tests for the exhaust application, and is incorporated herein by reference. The pH of the bath should be below 3.5. Excess water from the bath solution is removed by heating the substrate to affect the exhausting of the graft copolymer onto the substrate.

The following Preparative Examples and Examples further illustrate the present invention in detail but are not to be construed to limit the scope thereof. All parts and percentages in the examples are on a weight basis, unless indicated to the contrary.

### Water-Repellency Test

### (According to AATCC Test Method 193-2007)

A treated fabric (carpet) is stored in a thermo-hygrostat hygrostat having a temperature of 21° C. and a humidity of 65% for at least 4 hours. A test liquid (isopropyl alcohol (IPA), water, and a mixture thereof, as shown in Table 1) which has been also stored at 21° C. is used. The test is conducted in an air-conditioned room having a temperature of 21° C. and a humidity of 65%. Five droplets of the test liquid wherein one droplet has an amount of 50 μL are softly dropped by a micropipette on the fabric. If 4 or 5 droplets remain on the fabric after standing for 30 seconds, the test liquid passes the test. The water-repellency is expressed by a point corresponding to a maximum content of isopropyl alcohol (% by volume) in the test liquid which passes the test. The water-repellency is evaluated as twelve levels which are Fail, 0, 1, 2, 3, 4, 5, 6, 7, 8, 9 and 10 in order of a bad level to an excellent level.

TABLE 1
Water-repellency test liquid

(% by volume)

| | Isopropyl | |
|---|---|---|
| Point | alcohol | Water |
| 10 | 100 | 0 |
| 9 | 90 | 10 |
| 8 | 80 | 20 |
| 7 | 70 | 30 |
| 6 | 60 | 40 |
| 5 | 50 | 50 |
| 4 | 40 | 60 |
| 3 | 30 | 70 |
| 2 | 20 | 80 |
| 1 | 10 | 90 |
| 0 | 0 | 100 |

| | |
|---|---|
| Fail | Inferior to isopropyl |
| | alcohol 0/water 100 |

### Oil-Repellency Test

### (According to AATCC Test Method 118-2007)

A treated fabric (carpet) is stored in a thermo-hygrostat having a temperature of 21° C. and a humidity of 65% for at least 4 hours. A test liquid (shown in Table 2) which has been also stored at 21° C. is used. The test is conducted in an air-conditioned room having a temperature of 21° C. and a humidity of 65%. Five droplets of the test liquid wherein one droplet has an amount of 50 μL are softly dropped by a micropipette on the fabric. If 4 or 5 droplets remain on the fabric after standing for 30 seconds, the test liquid passes the test. The oil-repellency is expressed by a maximum point of the test liquid which passes the test. The oil-repellency is evaluated as nine levels which are Fail, 1, 2, 3, 4, 5, 6, 7 and 8 in order of a bad level to an excellent level.

TABLE 2
Oil-repellency test liquid

| | | Surface tension |
|---|---|---|
| Point | Test liquid | (dyne/cm, 25° C.) |
| 8 | n-Heptane | 20.0 |
| 7 | n-Octane | 21.8 |
| 6 | n-Decane | 23.5 |
| 5 | n-Dodecane | 25.0 |
| 4 | n-Tetradecane | 26.7 |
| 3 | n-Hexadecane | 27.3 |
| 2 | Mixture liquid of | 29.6 |
| | n-Hexadecane 35/nujol 65 | |
| 1 | Nujol | 31.2 |
| Fail | Inferior to 1 | — |

### Soil Resistance Test

The soil resistance test is performed according to ASTM D6540. A carpet is soiled with a dry soil having the composition shown in Table 3. The evaluation of soil resistance is made by comparing the soiled sample with a non-soiled carpet sample (which is before the soil resistance test) by a color-difference meter, to measure ΔE. The smaller the value of ΔE is, the better the soil resistance is.

TABLE 3

| Ingredients | Wt % |
|---|---|
| Peat moss | 39.1 |
| Portland cement | 18.0 |
| Kaolin | 18.0 |
| Silica (200 mesh) | 18.0 |
| Carbon black | 0.35 |
| Iron oxide (III) | 0.30 |
| Mineral oil | 6.25 |

### Durability Test

The carpet is subjected to cleaning according to AATCC 171-2005. Then, water- and oil-repellency and soil resistance are evaluated. A fluorine content of the carpet is measured to determine the fluorine content before and after the cleaning.

### Fluorine Content Measurement (Fluorine Remaining Rate Test)

A combustion flask is sufficiently washed with pure water. Then, 15 mL of pure water is charged into the combustion flask, and the weight of the flask containing water is measured. The weight of pure waster is determined by deducting a previously measured weight of the combustion flask from the weight of flask containing water. A platinum basket is heated twice or thrice to fully evaporate water. 75 mg of a carpet pile is weighed on a KIMWIPE, which is folded with enclosing a combustion aid (30 mg) and is positioned in the platinum basket. Oxygen is blown into the combustion flask, and the piles are burned and decomposed, and absorbed into pure water contained in the flask. After the absorption for 30 minutes, 10 mL of an absorption liquid and 10 mL of a buffer liquid (50 mL of acetic acid, 50 g of sodium chloride, 0.5 g of trisodium citrate dihydrate, and 32 g of sodium hydroxide are added to water to give a total amount of 1 L) are charged into a plastic cup and an F ion is measured by an F ion meter with sufficiently stirring. A fluorine adhesion amount and a fluorine remaining rate are calculated according to the following equations.

Fluorine adhesion amount [ppm]=(Measurement value [ppm]−Blank measurement value [ppm])×(Pure water weight [g]/Pile weight [mg])×1000

Fluorine remaining rate (%)=(Fluorine adhesion amount after cleaning [ppm])/(Fluorine adhesion amount before cleaning [ppm])×100

### PREPARATIVE EXAMPLE 1

A fluorine-containing graft polymer was prepared in the following procedure:

1. Dissolve 15.8 g of 10,000 MW, 80% hydrolyzed polyvinyl alcohol (PVA) in 140 g of water, purge solution with N₂ at room temperature while stirring, to give about 10% aqueous solution of PVA

2. Dissolve 1 g of Ceric Ammonium Nitrate (CAN) in 5 g of water and purge with N₂ at room temperature

3. Purge 24.8 g of a fluoroacrylate monomer with N₂ at room temperature

4. Inject the prepared CAN solution into PVA solution while stirring

5. Inject a monomer for branch (that is, the fluoroacrylate monomer) into PVA/CAN solution while stirring

Allow reaction to proceed at room temperature to give fluorine-containing water- and oil-repellent composition having a graft polymer content of 15-30% by weight, particularly 23% by weight

6. Recover after one hour, and measure a yield

The used fluoroacrylate monomer was as follows:
13-SFA: CF₃(CF₂) ₅(CH₂) ₂ OCO—CH═CH₂ ((2-(perfluorohexyl)ethyl acrylate)
13-SFMA: CF₃ (CF₂) ₅ (CH₂) ₂ OCO—C (CH₃)═CH₂ or
13-SFClA: CF₃ (CF₂) ₅ (CH₂) ₂ OCO—C (Cl)═CH₂

### PREPARATIVE EXAMPLE 2

The same procedure as in Preparative Example 1 was repeated except that the PVA solution contains 5% by weight (based on a resultant fluorine-containing water- and oil-repellent composition containing the graft polymer, the same hereinafter) of tripropylene glycol (TPG) as a solvent, in Step 1.

### PREPARATIVE EXAMPLE 3

The same procedure as in Preparative Example 1 was repeated except that the PVA solution contains 1.5% by weight of an emulsifier, in Step 1.

### PREPARATIVE EXAMPLE 4

The same procedure as in Preparative Example 1 was repeated except that the PVA solution contains both of 5% by weight of tripropylene glycol (TPG) and 0.5% by weight of an emulsifier, in Step 1.

### PREPARATIVE EXAMPLE 5

The same procedure as in Preparative Example 1 was repeated except that the N₂ purge was omitted in each of Steps 1, 2 and 3. After all were charged, the N₂ purge was conducted.

### PREPARATIVE EXAMPLE 6

The same procedure as in Preparative Example 1 was repeated except that a fluorine-free monomer (5 g) was added in the same step of purging the fluoroacrylate monomer.

The used fluorine-free monomer was as follows:
StA: Stearyl acrylate
MMA: Methyl methacrylate
EMA: Ethyl methacrylate
MA: Methyl acrylate
EA: Ethyl acrylate
2EHMA: 2-Ethylhexyl methacrylate, or
IBMA: Isobornyl methacrylate

### PREPARATIVE EXAMPLE 7

The same procedure as in Preparative Example 3 was repeated except that a fluorine-free monomer (5 g) was added in the same step of purging the fluoroacrylate monomer.

The used fluorine-free monomer was as follows:
StA: Stearyl acrylate
MMA: Methyl methacrylate
EMA: Ethyl methacrylate
MA: Methyl acrylate
EA: Ethyl acrylate
2EHMA: 2-Ethylhexyl methacrylate, or
IBMA: Isobornyl methacrylate

The ingredients in one of the resultant graft polymers are shown in Table I.

### PREPARATIVE EXAMPLE 8

The same procedure as in Preparative Example 2 was repeated except that a fluorine-free monomer (5 g) was added in the same step of purging the fluoroacrylate monomer.

### PREPARATIVE EXAMPLE 9

The same procedure as in Preparative Example 4 was repeated except that a fluorine-free monomer (5 g) was added in the same step of purging the fluoroacrylate monomer.

### PREPARATIVE EXAMPLE 10

The same procedure as in Preparative Example 1 was repeated except that each of the fluoroacrylate monomer, the fluorine-free monomer and the initiator was added in several portions during polymerization reaction.

### COMPARATIVE PREPARATIVE EXAMPLE 1

Fluoroacrylate (CF₃(CF₂)₅OCOCH═CH₂) (13-SFA) (32.5 g), methyl methacrylate (26.5 g), sodium a-olefin sulfonate (1.0 g), tripropylene glycol (10 g), deionized water (130 g) were mixed to give a mixture liquid. The mixture liquid was heated to 60° C. and emulsified by a high pressure homogenizer. The resultant emulsification liquid was charged into a 300 mL flask, a nitrogen replacement was conducted, and the dissolved O₂ was removed. 2,2′-Azobisamidinopropane dihydrochloride (0.5 g) was charged. The copolymerization reaction was conducted at 60° C. for 3 hours to give a copolymer emulsion. The copolymer emulsion was diluted with deionized water to give an aqueous fluorine-containing acrylate water- and oil-repellent composition having a solid content of 30% by weight. The composition of the resultant polymer was almost the same as the charged monomers.

### EXAMPLES 1 to 12

Tap water was added to the fluorine-containing water- and oil-repellent composition prepared in Preparative Example 7 to give a treatment liquid having a fluorine-containing polymer concentration of 0.5% by weight. The ingredients of the fluorine-containing water- and oil-repellent composition are shown in Table II. The emulsifier used was sodium α-olefin sulfonate. This treatment liquid was sprayed on a carpet (20 cm×20 cm, nylon 6, loop pile (density 26 oz/yd²)) to have a WPU (Wet Pick Up) of 30% (WPU is 30%, when 30 g of the liquid is on 100 g of the carpet), and air-dried at room temperature. Then, a water-repellency test, an oil repellency test, a soil resistance test and a durability test were carried out. The results are shown in Table II.

### EXAMPLES 13 to 24

The same procedure as in Examples 1-12 was repeated except that sodium lauryl sulfate was used as the emulsifier.

### EXAMPLES 25 to 36

The same procedure as in Examples 1-12 was repeated except that polyoxyethylene(20) (C₁₂-C₁₄)alkyl ether was used as the emulsifier.

### EXAMPLES 37 to 48

The same procedure as in Examples 1-12 was repeated except that (C₁₆-C₁₈) alkyl trimethyl ammonium chloride was used as the emulsifier.

### COMPARATIVE EXAMPLES 1 to 12

The same procedure as in Examples 1-12 was repeated except that a fluoroacrylate having a Rf perfluoroalkyl group having a carbon atom number of 4 (CF₃(CF₂)₃(CH₂)₂OCOCH═CH₂) (9-SFA) was used for the graft chain in Preparative Example 7.

### COMPARATIVE EXAMPLE 13

The same procedure as in Example 1 was repeated except that the fluorine-containing water- and oil-repellent composition prepared in Comparative Preparative Example 1 was used.

### EXAMPLES 49 to 60

Tap water and a stain blocking agent SB-715 (manufactured by Tri-tex Co. Inc.) (amount of the stain blocking agent is 10% by weight, based on total of water and stain blocking agent in a resultant treatment liquid) were added to the fluorine-containing water- and oil-repellent composition prepared in Preparative Example 7 to give a treatment liquid having a fluorine-containing polymer concentration of 0.5% by weight. The ingredients of the fluorine-containing water- and oil-repellent composition are shown in Table III. The emulsifier used was sodium α-olefin sulfonate. This treatment liquid was sprayed on a carpet (20 cm×20 cm, nylon 6, loop pile (density 26 oz/yd²)) to have a WPU (Wet Pick Up) of 30% (WPU is 30%, when 30 g of the liquid is on 100 g of the carpet), and air-dried at room temperature. Then, a water-repellency test, an oil repellency test, a soil resistance test and a durability test were carried out. The results are shown in Table III.

### EXAMPLES 61 to 72

The same procedure as in Examples 49-60 was repeated except that sodium lauryl sulfate was used as the emulsifier.

### EXAMPLES 73 to 84

The same procedure as in Examples 49-60 was repeated except that polyoxyethylene(20) (C₁₂-C₁₄)alkyl ether was used as the emulsifier.

### EXAMPLES 85 to 96

The same procedure as in Examples 49-60 was repeated except that (C₁₅-C₁₈) alkyl trimethyl ammonium chloride was used as the emulsifier.

### COMPARATIVE EXAMPLES 14 to 25

The same procedure as in Examples 49-60 was repeated except that a fluoroacrylate having a Rf perfluoroalkyl group having a carbon atom number of 4 (CF₃(CF₂)₃(CH₂)₂OCOCH═CH₂) (9-SFA) was used for the graft chain in Preparative Example 7.

### COMPARATIVE EXAMPLE 26

The same procedure as in Examples 49 was repeated except that the fluorine-containing water- and oil-repellent composition prepared in Comparative Preparative Example 1 was used.

Examples for Polymerization stability

A fluorine-containing water- and oil-repellent composition containing a graft copolymer shown Table I was prepared according to Preparative Example 6. Table I shows differences of polymerization stability caused from carbon number of perfluoroalkyl group. The polymerization stability was determined by observing the presence or absence of aggregates remaining in a polymerization reactor after the polymerization.

TABLE I

| Carbon number of | | | |
|---|---|---|---|
| perfluoroalkyl | | | Polymerization |
| group | Ingredients | Weight ratio | stability |
| 6 | PVA/13- | 35/55/10 | Absence of |
| | SFA/StA | | aggregates |
| 4 | PVA/9- | 35/55/10 | Absence of |
| | SFA/StA | | aggregates |
| 8 | PVA/17- | 35/55/10 | Presence of |
| | SFA/StA | | aggregates |

Note)
13-SFA: CF₃(CF₂)₅(CH₂)₂OCO—CH═CH₂
9-SFA: CF₃(CF₂)₃(CH₂)₂OCO—CH═CH₂
17-SFA: CF₃(CF₂)ₙ(CH₂)₂OCO—CH═CH₂ (average of n: 7)

TABLE II

| | | | | | | After cleaning | | | |
|---|---|---|---|---|---|---|---|---|---|
| | | | Before cleaning | | | | | | Fluorine |
| | | Weight | Oil | Water | Soil | Oil | Water | Soil | remaining |
| | Ingredients | ratio | rep. | rep. | res. | rep. | rep. | res. | rate |
| Ex. 1 | PVA/13-SFA/StA | 35/55/10 | 5 | 70 | 16 | 4 | 70 | 15 | 78% |
| Ex. 2 | PVA/13-SFMA/StA | 35/55/10 | 5 | 80 | 16 | 5 | 80 | 16 | 73% |
| Ex. 3 | PVA/13-SFClA/StA | 35/55/10 | 4 | 80 | 15 | 3 | 70 | 15 | 73% |
| Ex. 4 | PVA/13-SFA/MMA | 35/55/10 | 4 | 70 | 16 | 4 | 70 | 15 | 77% |
| Ex. 5 | PVA/13-SFMA/MMA | 35/55/10 | 4 | 70 | 16 | 3 | 70 | 16 | 78% |
| Ex. 6 | PVA/13-SFClA/MMA | 35/55/10 | 4 | 70 | 15 | 4 | 60 | 16 | 75% |
| Ex. 7 | PVA/13-SFA/EMA | 35/55/10 | 3 | 60 | 16 | 3 | 60 | 16 | 72% |
| Ex. 8 | PVA/13-SFA/2EHMA | 35/55/10 | 4 | 60 | 16 | 4 | 60 | 15 | 79% |
| Ex. 9 | PVA/13-SFA/MA | 35/55/10 | 4 | 70 | 16 | 4 | 70 | 16 | 72% |
| Ex. 10 | PVA/13-SFA/EA | 35/55/10 | 5 | 70 | 15 | 4 | 70 | 15 | 71% |
| Ex. 11 | PVA/13- | 35/55/5/5 | 5 | 70 | 16 | 4 | 70 | 15 | 76% |
| | SFA/MMA/EMA | | | | | | | | |
| Ex. 12 | PVA/13-SFA/IBMA | 35/55/10 | 5 | 80 | 16 | 4 | 80 | 16 | 75% |
| Ex. 13 | PVA/13-SFA/StA | 35/55/10 | 5 | 80 | 15 | 4 | 70 | 15 | 75% |
| Ex. 14 | PVA/13-SFMA/StA | 35/55/10 | 4 | 80 | 16 | 4 | 80 | 16 | 76% |
| Ex. 15 | PVA/13-SFClA/StA | 35/55/10 | 4 | 80 | 16 | 3 | 70 | 16 | 77% |
| Ex. 16 | PVA/13-SFA/MMA | 35/55/10 | 4 | 70 | 16 | 4 | 70 | 16 | 72% |
| Ex. 17 | PVA/13-SFMA/MMA | 35/55/10 | 3 | 70 | 16 | 3 | 60 | 16 | 74% |
| Ex. 18 | PVA/13-SFClA/MMA | 35/55/10 | 5 | 70 | 16 | 4 | 60 | 15 | 73% |
| Ex. 19 | PVA/13-SFA/EMA | 35/55/10 | 3 | 60 | 17 | 3 | 60 | 17 | 78% |
| Ex. 20 | PVA/13-SFA/2EHMA | 35/55/10 | 4 | 70 | 16 | 3 | 70 | 20 | 80% |
| Ex. 21 | PVA/13-SFA/MA | 35/55/10 | 4 | 60 | 16 | 3 | 60 | 19 | 71% |
| Ex. 22 | PVA/13-SFA/EA | 35/55/10 | 3 | 60 | 17 | 3 | 50 | 17 | 72% |
| Ex. 23 | PVA/13- | 35/55/5/5 | 4 | 60 | 16 | 3 | 60 | 16 | 74% |
| | SFA/MMA/EMA | | | | | | | | |
| Ex. 24 | PVA/13-SFA/IBMA | 35/55/10 | 4 | 70 | 16 | 3 | 60 | 17 | 74% |
| Ex. 25 | PVA/13-SFA/StA | 35/55/10 | 5 | 70 | 16 | 4 | 70 | 15 | 75% |
| Ex. 26 | PVA/13-SFMA/StA | 35/55/10 | 5 | 70 | 16 | 5 | 70 | 16 | 74% |
| Ex. 27 | PVA/13-SFClA/StA | 35/55/10 | 4 | 70 | 15 | 3 | 70 | 15 | 74% |
| Ex. 28 | PVA/13-SFA/MMA | 35/55/10 | 4 | 60 | 16 | 4 | 60 | 15 | 75% |
| Ex. 29 | PVA/13-SFMA/MMA | 35/55/10 | 4 | 60 | 16 | 3 | 60 | 16 | 74% |
| Ex. 30 | PVA/13-SFClA/MMA | 35/55/10 | 3 | 60 | 15 | 3 | 50 | 16 | 77% |
| Ex. 31 | PVA/13-SFA/EMA | 35/55/10 | 3 | 60 | 16 | 3 | 60 | 16 | 77% |
| Ex. 32 | PVA/13-SFA/2EHMA | 35/55/10 | 4 | 70 | 16 | 4 | 70 | 15 | 75% |
| Ex. 33 | PVA/13-SFA/MA | 35/55/10 | 4 | 70 | 16 | 4 | 70 | 16 | 72% |
| Ex. 34 | PVA/13-SFA/EA | 35/55/10 | 5 | 70 | 15 | 4 | 70 | 15 | 73% |
| Ex. 35 | PVA/13- | 35/55/5/5 | 5 | 70 | 16 | 4 | 60 | 15 | 75% |
| | SFA/MMA/EMA | | | | | | | | |
| Ex. 36 | PVA/13-SFA/IBMA | 35/55/10 | 5 | 80 | 16 | 4 | 70 | 16 | 74% |
| Ex. 37 | PVA/13-SFA/StA | 35/55/10 | 5 | 80 | 16 | 4 | 70 | 15 | 74% |
| Ex. 38 | PVA/13-SFMA/StA | 35/55/10 | 5 | 80 | 16 | 5 | 70 | 16 | 76% |
| Ex. 39 | PVA/13-SFClA/StA | 35/55/10 | 4 | 80 | 15 | 3 | 70 | 15 | 75% |
| Ex. 40 | PVA/13-SFA/MMA | 35/55/10 | 4 | 70 | 16 | 4 | 70 | 15 | 77% |
| Ex. 41 | PVA/13-SFMA/MMA | 35/55/10 | 4 | 70 | 16 | 3 | 60 | 16 | 72% |
| Ex. 42 | PVA/13-SFClA/MMA | 35/55/10 | 3 | 70 | 15 | 3 | 60 | 16 | 78% |
| Ex. 43 | PVA/13-SFA/EMA | 35/55/10 | 3 | 70 | 16 | 3 | 60 | 16 | 73% |
| Ex. 44 | PVA/13-SFA/2EHMA | 35/55/10 | 4 | 60 | 16 | 4 | 60 | 15 | 80% |
| Ex. 45 | PVA/13-SFA/MA | 35/55/10 | 4 | 60 | 16 | 4 | 60 | 16 | 74% |
| Ex. 46 | PVA/13-SFA/EA | 35/55/10 | 5 | 60 | 15 | 4 | 60 | 15 | 75% |
| Ex. 47 | PVA/13- | 35/55/5/5 | 5 | 60 | 16 | 4 | 60 | 15 | 77% |
| | SFA/MMA/EMA | | | | | | | | |
| Ex. 48 | PVA/13-SFA/IBMA | 35/55/10 | 5 | 70 | 16 | 4 | 70 | 16 | 74% |
| Com. | PVA/9-SFA/StA | 35/55/10 | 2 | 20 | 21 | 1 | 20 | 21 | 73% |
| Ex. 1 | | | | | | | | | |
| Com. | PVA/9-SFMA/StA | 35/55/10 | 1 | 20 | 22 | 1 | 10 | 21 | 72% |
| Ex. 2 | | | | | | | | | |
| Com. | PVA/9-SFClA/StA | 35/55/10 | 2 | 20 | 20 | 2 | 20 | 20 | 72% |
| Ex. 3 | | | | | | | | | |
| Com. | PVA/9-SFA/MMA | 35/55/10 | 2 | 10 | 21 | 1 | 10 | 20 | 74% |
| Ex. 4 | | | | | | | | | |
| Com. | PVA/9-SFMA/MMA | 35/55/10 | 1 | 10 | 22 | 1 | 0 | 22 | 76% |
| Ex. 5 | | | | | | | | | |
| Com. | PVA/9-SFClA/MMA | 35/55/10 | 2 | 10 | 21 | 2 | 10 | 21 | 74% |
| Ex. 6 | | | | | | | | | |
| Com. | PVA/9-SFA/EMA | 35/55/10 | 2 | 10 | 21 | 1 | 10 | 21 | 72% |
| Ex. 7 | | | | | | | | | |
| Com. | PVA/9-SFA/2EHMA | 35/55/10 | 0 | 20 | 20 | 0 | 10 | 20 | 75% |
| Ex. 8 | | | | | | | | | |
| Com. | PVA/9-SFA/MA | 35/55/10 | 2 | 20 | 21 | 1 | 10 | 21 | 70% |
| Ex. 9 | | | | | | | | | |
| Com. | PVA/9-SFA/EA | 35/55/10 | 1 | 20 | 21 | 0 | 10 | 21 | 71% |
| Ex. 10 | | | | | | | | | |
| Com. | PVA/9- | 35/55/5/5 | 2 | 20 | 22 | 1 | 10 | 21 | 75% |
| Ex. 11 | SFA/MMA/EMA | | | | | | | | |
| Com. | PVA/9-SFA/IBMA | 35/55/10 | 0 | 10 | 22 | 0 | 10 | 22 | 75% |
| Ex. 12 | | | | | | | | | |
| Com. | 13-SFA/MMA | 55/45 | 2 | 20 | 20 | 0 | 10 | 23 | 48% |
| Ex. 13 | | | | | | | | | |

TABLE III

| | | | | | | After cleaning | | | |
|---|---|---|---|---|---|---|---|---|---|
| | | | Before cleaning | | | | | | Fluorine |
| | | Weight | Oil | Water | Soil | Oil | Water | Soil | remaining |
| | Ingredients | ratio | rep. | rep. | res. | rep. | rep. | res. | rate |
| Ex. 49 | PVA/13-SFA/StA | 35/55/10 | 2 | 10 | 13 | 2 | 10 | 12 | 71% |
| Ex. 50 | PVA/13-SFMA/StA | 35/55/10 | 1 | 10 | 13 | 1 | 10 | 12 | 72% |
| Ex. 51 | PVA/13-SFClA/StA | 35/55/10 | 2 | 10 | 13 | 2 | 10 | 12 | 74% |
| Ex. 52 | PVA/13-SFA/MMA | 35/55/10 | 2 | 10 | 12 | 2 | 10 | 11 | 74% |
| Ex. 53 | PVA/13-SFMA/MMA | 35/55/10 | 1 | 10 | 12 | 1 | 10 | 11 | 75% |
| Ex. 54 | PVA/13-SFClA/MMA | 35/55/10 | 2 | 10 | 11 | 2 | 10 | 10 | 74% |
| Ex. 55 | PVA/13-SFA/EMA | 35/55/10 | 2 | 10 | 12 | 2 | 10 | 11 | 74% |
| Ex. 56 | PVA/13-SFA/2EHMA | 35/55/10 | 2 | 10 | 12 | 2 | 10 | 12 | 73% |
| Ex. 57 | PVA/13-SFA/MA | 35/55/10 | 1 | 10 | 12 | 1 | 10 | 11 | 75% |
| Ex. 58 | PVA/13-SFA/EA | 35/55/10 | 2 | 10 | 12 | 2 | 10 | 11 | 74% |
| Ex. 59 | PVA/13- | 35/55/5/5 | 2 | 10 | 12 | 2 | 10 | 12 | 74% |
| | SFA/MMA/EMA | | | | | | | | |
| Ex. 60 | PVA/13-SFA/IBMA | 35/55/10 | 2 | 10 | 13 | 2 | 10 | 12 | 76% |
| Ex. 61 | PVA/13-SFA/StA | 35/55/10 | 2 | 10 | 13 | 2 | 10 | 12 | 75% |
| Ex. 62 | PVA/13-SFMA/StA | 35/55/10 | 2 | 10 | 12 | 2 | 10 | 12 | 76% |
| Ex. 63 | PVA/13-SFClA/StA | 35/55/10 | 1 | 10 | 12 | 1 | 10 | 11 | 77% |
| Ex. 64 | PVA/13-SFA/MMA | 35/55/10 | 2 | 10 | 12 | 2 | 0 | 12 | 72% |
| Ex. 65 | PVA/13-SFMA/MMA | 35/55/10 | 2 | 10 | 11 | 2 | 10 | 10 | 74% |
| Ex. 66 | PVA/13-SFClA/MMA | 35/55/10 | 2 | 10 | 11 | 1 | 0 | 10 | 73% |
| Ex. 67 | PVA/13-SFA/EMA | 35/55/10 | 1 | 10 | 12 | 2 | 0 | 11 | 78% |
| Ex. 68 | PVA/13-SFA/2EHMA | 35/55/10 | 2 | 10 | 13 | 2 | 10 | 12 | 77% |
| Ex. 69 | PVA/13-SFA/MA | 35/55/10 | 2 | 10 | 12 | 2 | 0 | 11 | 72% |
| Ex. 70 | PVA/13-SFA/EA | 35/55/10 | 2 | 10 | 12 | 1 | 0 | 11 | 74% |
| Ex. 71 | PVA/13- | 35/55/5/5 | 1 | 10 | 12 | 2 | 0 | 12 | 77% |
| | SFA/MMA/EMA | | | | | | | | |
| Ex. 72 | PVA/13-SFA/IBMA | 35/55/10 | 2 | 10 | 13 | 2 | 0 | 12 | 72% |
| Ex. 73 | PVA/13-SFA/StA | 35/55/10 | 2 | 10 | 13 | 2 | 10 | 12 | 74% |
| Ex. 74 | PVA/13-SFMA/StA | 35/55/10 | 2 | 10 | 13 | 2 | 10 | 12 | 74% |
| Ex. 75 | PVA/13-SFClA/StA | 35/55/10 | 1 | 10 | 13 | 1 | 0 | 12 | 75% |
| Ex. 76 | PVA/13-SFA/MMA | 35/55/10 | 1 | 10 | 12 | 1 | 0 | 12 | 74% |
| Ex. 77 | PVA/13-SFMA/MMA | 35/55/10 | 2 | 10 | 11 | 2 | 0 | 11 | 77% |
| Ex. 78 | PVA/13-SFClA/MMA | 35/55/10 | 2 | 10 | 12 | 2 | 0 | 11 | 73% |
| Ex. 79 | PVA/13-SFA/EMA | 35/55/10 | 2 | 10 | 12 | 2 | 10 | 12 | 78% |
| Ex. 80 | PVA/13-SFA/2EHMA | 35/55/10 | 1 | 10 | 12 | 1 | 0 | 12 | 77% |
| Ex. 81 | PVA/13-SFA/MA | 35/55/10 | 2 | 10 | 12 | 2 | 10 | 11 | 72% |
| Ex. 82 | PVA/13-SFA/EA | 35/55/10 | 2 | 10 | 12 | 2 | 0 | 11 | 74% |
| Ex. 83 | PVA/13- | 35/55/5/5 | 2 | 10 | 12 | 2 | 0 | 12 | 77% |
| | SFA/MMA/EMA | | | | | | | | |
| Ex. 84 | PVA/13-SFA/IBMA | 35/55/10 | 2 | 10 | 13 | 2 | 0 | 12 | 72% |
| Ex. 85 | PVA/13-SFA/StA | 35/55/10 | 2 | 10 | 13 | 2 | 0 | 13 | 78% |
| Ex. 86 | PVA/13-SFMA/StA | 35/55/10 | 1 | 10 | 13 | 1 | 10 | 12 | 77% |
| Ex. 87 | PVA/13-SFClA/StA | 35/55/10 | 2 | 10 | 13 | 2 | 0 | 12 | 72% |
| Ex. 88 | PVA/13-SFA/MMA | 35/55/10 | 2 | 10 | 12 | 2 | 10 | 12 | 72% |
| Ex. 89 | PVA/13-SFMA/MMA | 35/55/10 | 2 | 10 | 12 | 2 | 0 | 12 | 78% |
| Ex. 90 | PVA/13-SFClA/MMA | 35/55/10 | 1 | 10 | 12 | 1 | 0 | 11 | 77% |
| Ex. 91 | PVA/13-SFA/EMA | 35/55/10 | 2 | 10 | 12 | 2 | 0 | 12 | 72% |
| Ex. 92 | PVA/13-SFA/2EHMA | 35/55/10 | 2 | 10 | 13 | 2 | 0 | 12 | 78% |
| Ex. 93 | PVA/13-SFA/MA | 35/55/10 | 2 | 10 | 12 | 2 | 10 | 12 | 77% |
| Ex. 94 | PVA/13-SFA/EA | 35/55/10 | 2 | 10 | 12 | 2 | 10 | 11 | 72% |
| Ex. 95 | PVA/13- | 35/55/5/5 | 1 | 10 | 12 | 1 | 0 | 11 | 74% |
| | SFA/MMA/EMA | | | | | | | | |
| Ex. 96 | PVA/13-SFA/IBMA | 35/55/10 | 2 | 10 | 13 | 2 | 0 | 12 | 77% |
| Com. | PVA/9-SFA/StA | 35/55/10 | 0 | 10 | 19 | 0 | 0 | 19 | 72% |
| Ex. 14 | | | | | | | | | |
| Com. | PVA/9-SFMA/StA | 35/55/10 | 0 | 0 | 19 | 0 | 0 | 19 | 78% |
| Ex. 15 | | | | | | | | | |
| Com. | PVA/9-SFClA/StA | 35/55/10 | 0 | 10 | 19 | 0 | 10 | 18 | 77% |
| Ex. 16 | | | | | | | | | |
| Com. | PVA/9-SFA/MMA | 35/55/10 | 0 | 10 | 18 | 0 | 10 | 18 | 72% |
| Ex. 17 | | | | | | | | | |
| Com. | PVA/9-SFMA/MMA | 35/55/10 | 1 | 10 | 19 | 1 | 0 | 19 | 74% |
| Ex. 18 | | | | | | | | | |
| Com. | PVA/9-SFClA/MMA | 35/55/10 | 0 | 10 | 19 | 0 | 10 | 19 | 74% |
| Ex. 19 | | | | | | | | | |
| Com. | PVA/9-SFA/EMA | 35/55/10 | 0 | 10 | 19 | 0 | 10 | 18 | 73% |
| Ex. 20 | | | | | | | | | |
| Com. | PVA/9-SFA/2EHMA | 35/55/10 | 0 | 0 | 19 | 0 | 0 | 18 | 75% |
| Ex. 21 | | | | | | | | | |
| Com. | PVA/9-SFA/MA | 35/55/10 | 1 | 10 | 18 | 0 | 10 | 18 | 74% |
| Ex. 22 | | | | | | | | | |
| Com. | PVA/9-SFA/EA | 35/55/10 | 0 | 10 | 19 | 0 | 0 | 19 | 76% |
| Ex. 23 | | | | | | | | | |
| Com. | PVA/9- | 35/55/5/5 | 1 | 10 | 18 | 1 | 10 | 18 | 75% |
| Ex. 24 | SFA/MMA/EMA | | | | | | | | |
| Com. | PVA/9-SFA/IBMA | 35/55/10 | 0 | 0 | 19 | 0 | 0 | 18 | 75% |
| Ex. 25 | | | | | | | | | |
| Com. | 13-SFA/MMA | 55/45 | 2 | 10 | 17 | 0 | 0 | 21 | 44% |
| Ex. 26 | | | | | | | | | |

Note)
13-SFA: CF₃(CF₂)₅(CH₂)₂OCO—CH═CH₂
13-SFMA: CF₃(CF₂)₅(CH₂)₂OCO—C(CH₃)═CH₂
13-SFClA: CF₃(CF₂)₅(CH₂)₂OCO—C(Cl)═CH₂
9-SFA: CF₃(CF₂)₃(CH₂)₂OCO—CH═CH₂
17-SFA: CF₃(CF₂)ₙ(CH₂)₂OCO—CH═CH₂ (average of n: 7)
StA: Stearyl acrylate
MMA: Methyl methacrylate
EMA: Ethyl methacrylate
MA: Methyl acrylate
EA: Ethyl acrylate
2EHMA: 2-Ethylhexyl methacrylate
IBMA: Isobornyl methacrylate

1. A repellent composition comprising:
an aqueous continuous phase; and
a graft copolymer, dispersed in the aqueous continuous phase, comprising
a water-soluble polymer trunk having a hydroxyl group; and
a branch having a C₆-perfluoroalkyl group bonded to the polymer trunk at a carbon atom substituted with the hydroxyl group.

2. The repellent composition according to claim 1, wherein the water-soluble polymer trunk having a hydroxyl group is a homopolymer of vinyl alcohol or a copolymer of vinyl alcohol and vinyl acetate.

3. The repellent composition according to claim 1, wherein the branch comprises a fluorine-containing polymer comprising a perfluoroalkyl group-containing (meth)acrylate represented by the following general formula:
Rf—A²—OCOCR¹⁸═CH₂ (R_{f}M)
wherein Rf is a perfluoroalkyl group having 6 carbon atoms,
R¹⁸ is hydrogen, halogen (for example, fluorine, chlorine, bromine and iodine), or a methyl group, and
A² is a divalent organic group.

4. The repellent composition according to claim 1, wherein the branch further contains a fluorine-free vinyl monomer.

5. The repellent composition according to claim 4, wherein the fluorine-free vinyl monomer is an alkyl (meth)acrylate in which the carbon number of the alkyl group is 1 to 30.

6. A graft copolymer comprising a water-soluble polymer trunk having hydroxyl groups and branches having a C₆-perfluoroalkyl group bonded to the polymer trunk at a carbon atom substituted with a hydroxyl group.

7. A method of preparing a treated substrate, comprising applying the repellent composition according to claim 1, and drying the substrate at a room temperature to impart water- and oil-repellency and soil resistance.

8. A substrate which is treated with the repellent composition according to claim 1.

9. The treated substrate according to claim 8, wherein the substrate is a fibrous substrate selected from the group consisting of paper, textiles, carpet and nonwoven materials.

10. The treated substrate according to claim 8, wherein the substrate is nonfibrous selected from the group consisting of metals, plastics, leathers, composites, and glasses, both treated and untreated, porous and non porous.

11. Use of, as a water- and oil-repellent agent, the repellent composition according to claim 1.
